(19) United States
(12) Patent Application Publication
(10) Pub. No.: US 2009/0158197 A1
(43) Pub. Date: Jun. 18, 2009

(54) TWO PANEL NAVIGATION

(75) Inventors: Gerrit Hollemans, Eindhoven (NL); Vincentius Paulus Buil, Eindhoven (NL); Marco Van Leeuwen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,901

(22) PCT Filed: Jan. 3, 2005
(86) PCT No.: PCT/IB05/50004

§ 371 Date: Jun. 28, 2006

(30) Foreign Application Priority Data
Jan. 9, 2004 (EP) 04100047.2

(51) Int. Cl. G06F 3/048

(52) U.S. Cl. 715/781

(57) ABSTRACT

A graphical user interface for navigating through content is provided. The graphical user interface comprises a history panel wherein navigation history data is displayed so as to represent past selections, and furthermore comprises at least a first panel displaying a first menu of a content structure. The first menu comprises one or more selectable items. A further at least second panel for displaying a first sub-menu of a currently highlighted item of the first menu may be provided. By providing information about navigation history data to the user in a history panel, the user is provided with a general overview of the content and also of the current navigation process and/or the overall navigation structure. By providing navigation history information in a history panel, the past dialog boxes may be closed without loosing any information regarding the current navigation process.

### FIELD OF INVENTION

The present invention relates to a graphical user interface and a computer system or a television system comprising the graphical user interface. Furthermore, a method of navigating through content is provided.

### BACKGROUND OF THE INVENTION

Typically, when users navigate through content they need information on the flow of navigation. That is, they need to know in which area they are navigating, what steps are to be taken, what are the possible next steps and also what are the consequences of a certain step on the next steps.

In many systems the greatest emphasis is put on the history of the navigation, i.e. what steps have been taken. So, typically, all navigation history remains present and take up screen space, as it is for example seen in Windows Start Menu. This way of presenting most often result in a visual clutter instead of providing an overview of the navigation to a user. In many cases the user gets information on the next step in the navigation if the current step is (halfway) completed, whereas the navigation history remains present.

### SUMMARY OF THE INVENTION

It is an object of the present invention to provide a graphical user interface allowing for simple navigation through content.

According to one aspect of the present invention the above and other objects are fulfilled by providing a graphical user interface for navigating through content, the graphical user interface comprising a history panel wherein navigation history data is displayed, and at least a first panel displaying a first menu of a content structure, the first menu comprising one or more selectable items.

The graphical user interface may further comprise at least a second panel for displaying a first sub-menu of a currently highlighted item of the first menu.

It is an advantage of providing information about navigation history data to the user in a history panel that the user is provided with a general overview of the content and also of the current navigation process and/or the overall navigation structure. By providing navigation history information in a history panel, the past dialog boxes may be closed without loosing any information regarding the current navigation process. Thus, the history panel may display navigation history data so as to represent past selections.

The content may be structured in any way, the content may be a web of pages, hierarchically ordered content, etc. Preferably, the content is ordered so that the selections in one panel determines what is possible beyond that point. It is envisaged that more routes through the content may lead to the same panel, so that different selections in a previous menu may lead to the same panel in a later menu.

The menu of the content structure may be any content displayed in a panel, it may thus be any menu, such as any list of items or containers, etc.

The history panel may provide a better understanding of the navigation process to the user and a visual clutter and/or information overload may be avoided.

In a preferred embodiment, the graphical user interface is used for navigating in content on Consumer Electronic (CE) devices and particularly for accessing entertainment content on a CE device. A CE device may be any consumer electronic device, such as wireless devices, such as Handheld PC's, Pocket PC's Palm size PC's, PDA's (Personal Digital Assistants), PalmPilot's, etc.

In another preferred embodiment, the graphical user interface is used for television navigation and/or for browsing in multimedia content.

The navigation may be an interactive navigation so that a specific selection provides a number of possibilities which were not available before this selection was made.

The graphical user interface comprises at least a first panel displaying a first menu of a content structure, wherein the first menu comprises one or more selectable items. Preferably, the graphical user interface also comprises at least a second panel for showing a sub-menu of the first menu. It is an advantage of showing a next step in the navigation path so that the user knows what will be the result of a selection before the selection is made.

Preferably, the navigation history data is updated with a reference to the menu displayed in the first panel upon selection of an item of the menu. Hereby, the navigation history data panel is immediately updated and the navigation history is shown in the history panel.

Furthermore, the first menu in the first panel may be replaced with the sub-menu previously shown in the second panel upon selection of an item in the first panel. The sub-menu in the second panel may then be replaced with a sub-sub-menu of a currently highlighted item of the first sub-menu. In this way navigation through a complex menu may be visualised by means of two static panels, i.e. panels in which the content is shifted but the panels remain on the screen. This allows for a simple two-panel navigation overview.

It is envisaged that also more than two panels may be provided so that for example also three, four, five, six, seven or eight panels may be provided. The number of panels may be selected depending on the content browsed by the user and the amount of details the user wants to be shown. In a preferred embodiment, the user may be able to select the number of panels of the graphical user interface. Preferably, both standard or global settings and settings for a specific navigation section or process may be selected by the user.

The navigation history data may comprise elements representing a reference to a previous selection. Thus, the navigation history data may comprise a reference to all previous selections or the navigation history data may show only some of the historical selections. The shown navigation history data may be shown according to different criteria. Thus, for example the last number of selections may be shown, the number may be any integer number, so that for example the at least 2, 3, 5 or 10 last selections may be shown in the navigation history panel. Additionally or alternatively, only specific selections are shown, such as e.g. main menu selections or specific actions.

The content structure may comprise a main menu starting point. The navigation history data may then comprise navigation history data starting from the main menu starting point.

Thus, the navigation history data may comprise lists, folders and any choices that the user made on storage devices, type of content, navigation method and related choices, etc. The elements of the navigation history panel may be of same or different types. For example a selection of a specific language, the selection of a time zone, selection of storage devices, and type of content, etc. may be shown or illustrated in the navigation history panel. The user may use a selection element for selection of certain elements. E.g. using mouse operations or key strokes to perform the selections.

The navigation history data may be represented by any means, such as by any graphical or textual based means or any combination of graphical and textual based means. The navigation history data may thus be represented by short textual representation, by pictograms, by dedicated buttons, icons, etc. Furthermore, one or more layered panels may show the navigation history. Preferably, the one or more layered panels are associated with the navigation history panel so that for each element or reference in the navigation history panel representing navigation history data, a thin panel may be provided e.g. along a side of the first panel, or at any other suitable place. When more elements or references are provided in the navigation history panel, these thin panels may be layered.

The navigation history panel may be an active panel so that e.g. a user navigating in content, may use elements of the navigation history panel to revert to a previous position in the navigation history. For example by selecting a specific reference or element in the navigation history panel or by selecting a specific one of the layered panels, the user may revert to a previous position in the navigation history. The selections made after this previous position in the navigation history may then be cancelled. Alternatively, the selections made may be retained.

A computer program product may be provided, the computer program product enabling a programmable device when executing said computer program product to function as a graphical user interface as defined above.

According to another aspect of the invention a computer system is provided, the computer system comprising data in a content structure, and the system further comprises a graphical user interface as described above for navigating through the data.

According to another aspect of the invention, a computer system operable to provide navigation through content is provided, the computer system comprising

displaying means for displaying elements representing navigation history data in a navigation history panel and at least a first menu of a structure in at least a first panel, the first menu comprising one or more selectable items.

Furthermore, a computer program operable to provide navigation through content is provided, the computer program comprising elements for displaying elements representing navigation history data in a navigation history panel and for displaying at least a first menu of a content structure in at least a first panel, the first menu comprising one or more selectable items.

A ‘computer program’ is to be understood to mean any software product stored on a computer-readable medium, such as a floppy-disk, downloadable via a network, such as the Internet, or marketable in any other manner.

According to a further aspect of the invention a method of navigating through content is provided, the method comprising displaying elements representing navigation history data in a navigation history panel and displaying at least a first menu of a content structure in at least a first panel, the first menu comprising one or more selectable items.

The elements representing navigation history data may be active elements, so that for example the selection of such an active element may cause the navigation to revert to the selected data or the selected position in the navigation history data.

A computer program product may enable a programmable device when executing said computer program product to function as a method as defined above.

### BRIEF DESCRIPTION OF THE DRAWINGS

FIG. 1 shows an example of a graphical user interface for navigation in content,

FIG. 2 shows another example of a graphical user interface, and

FIG. 3 shows another graphical user interface comprising layered panels.

FIG. 4 shows a graphical user interface comprising layered panels.

### DETAILED DESCRIPTION OF A THE DRAWINGS

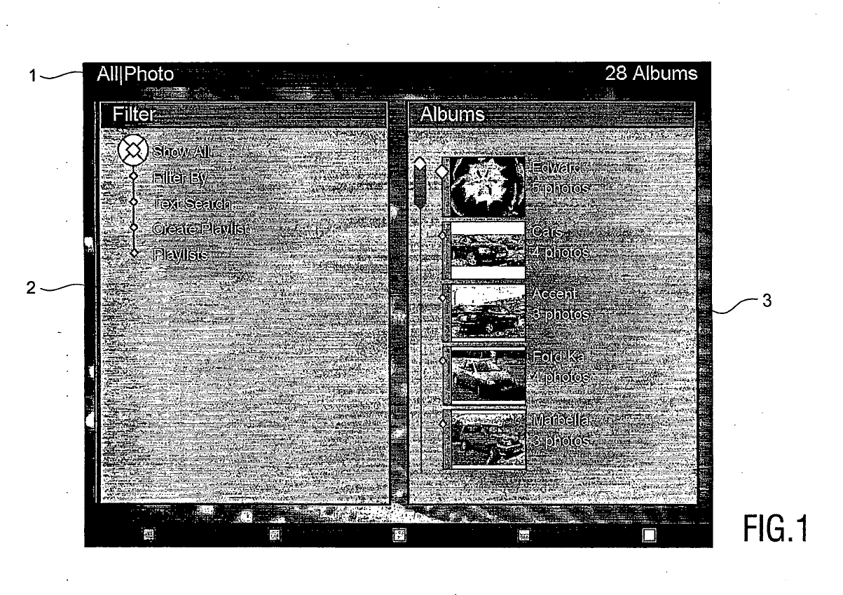

In FIG. 1, a graphical user interface according to the invention is shown. A navigation history panel 1 is provided in the top of the window, and a first panel 2 comprising the possible options are shown. The options comprises the following possibilities: “Show all”, “Filter By”, “Text Search”, “Create Playlist”, “Playlists”. The option “Show all” is pre-selected. A second panel 3 is also provided and it is seen that the next step is browsing through albums. The second panel 3 comprising the possible selections of the “Show all” folder. The Albums “Edward”, “Cars”, “Accent”, “Ford Ka” and “Marbella” all comprising photos are shown. It is seen from the navigation history panel 1 in the upper left corner of the window that “All”, e.g. all storage devices, is selected and that the content type “Photo” is also selected in previous steps. It is also seen in the navigation history panel that there is a total of 28 Albums available of content type “Photo” as seen in the upper left representation of the content in the navigation history panel.

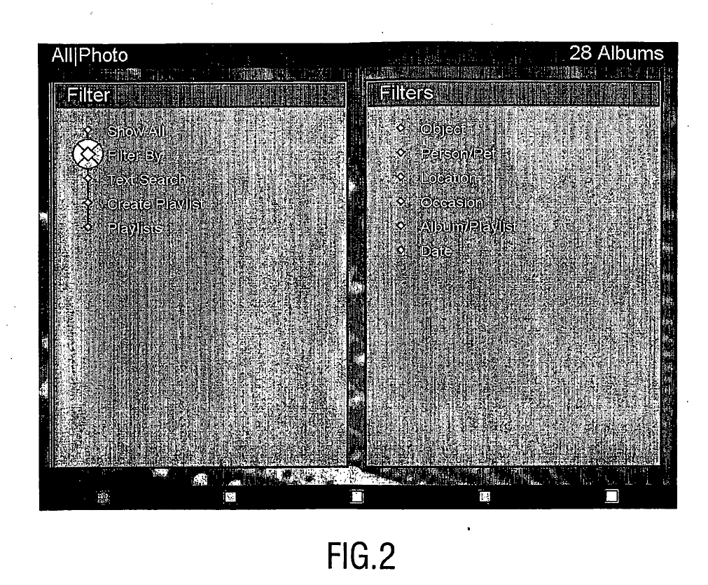

FIG. 2 shows the graphical user interface of FIG. 1, wherein the option “Filter By” is currently selected as shown in the first panel 2 and the next step is the selection of specific filters. Also here, “All” storage devices and content type photo are already selected as seen in the navigation history panel 1. The representation of the selections in the navigation history panel are all textual representations. The possible filters to be selected are provided in the second panel 3, and may be “Object”, “Person/Pet”, “Location”, “Occasion”, “Album/Playlist”, and “Date”.

There may be more than one route to the same panel, so that to arrive at a specific item more routes through content may be used. E.g. to arrive at item x e.g. a holiday picture, the route through Photo->show all->album-> item x may be chosen. An alternative route to item x may be Photo->filter->occasion->holiday->album-> item x. Thus, two or more alternate routes may lead to the same result.

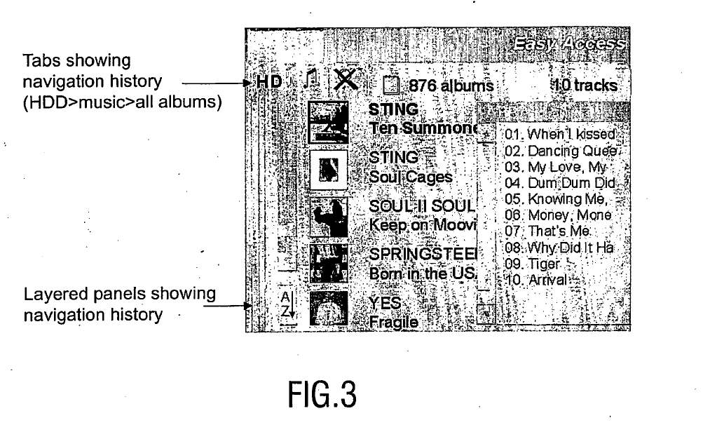

FIG. 3 shows another embodiment of a graphical user interface according to the present invention. In this embodiment, the elements or references in the navigation history panel 5 is a combination of textual and graphical representation. Furthermore, each element is provided with a specific tab 6 and in the illustrated example, the storage device “HDD” is selected, and also “music” and “all albums” are previously selected. Furthermore, layered panels 7 associated with each element is seen along a left side of the window. It is seen that a total of 876 albums are available.

The visible albums in the first panel 9 are Sting “Ten Summons”, “Soul Cages”, and “Soul II Soul”, Bruce Springsteen “Born in the USA” and Yes “Fragile”. It is seen that the album ABBA “Arrival” is pre-selected and the content of this album is shown in the second panel 10, being “When I kissed”, “Dancing Queen”, “My Love . . . ”, “Dum Dum Did”, “Knowing Me . . . ”, “Money Money . . . ”, “That's Me”, “Why did it happen”, “Tiger”, and “Arrival”. It is furthermore seen that the albums are sorted alphabetically by the icon 11 and that more pages of the albums may be seen by using the scroll bar 12.

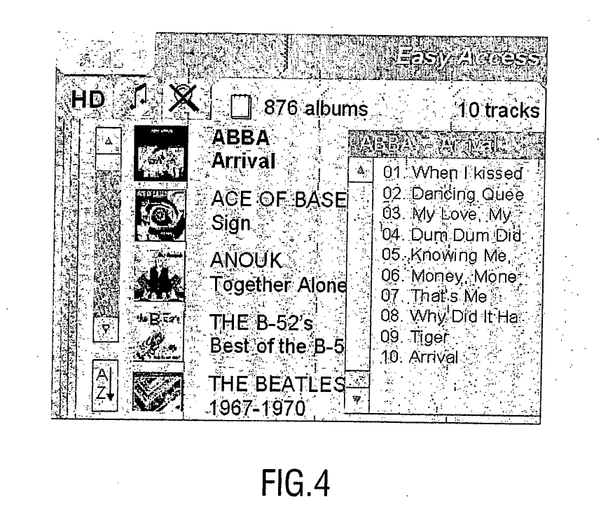

It is seen that the previously selected item was ABBA with “Arrival” as is seen in FIG. 4.

1. A graphical user interface for navigating through content comprising
a history panel wherein navigation history data is displayed, and
at least a first panel displaying a first menu of a content structure, the first menu comprising one or more selectable items.

2. A graphical user interface according to claim 1, further comprising at least a second panel for displaying a first sub-menu of a currently highlighted item of the first menu.

3. A graphical user interface according to claim 1, wherein navigation history data is updated with a reference to the menu displayed in the first panel upon selection of an item of the menu.

4. A graphical user interface according to claim 2, wherein the first menu in the first panel is replaced with the sub-menu of the second panel upon selection of an item in the first panel.

5. A graphical user interface according to claim 4, wherein the sub-menu in the second panel is replaced with a sub-menu of a currently highlighted item of the first sub-menu.

6. A graphical user interface according to claim 1, wherein the navigation history data comprises a reference to previously selected menu(s).

7. A graphical user interface according to claim 1, wherein the navigation history data is displayed as pictograms.

8. A graphical user interface according to claim 1, wherein one or more layered panels show the navigation history.

9. A graphical user interface according to claim 1, wherein the content structure comprises a main menu starting point.

10. A graphical user interface according to claim 9, wherein the navigation history data comprises navigation history data starting from the main menu starting point.

11. A graphical user interface according to claim 9, wherein the navigation history data comprises navigation history for a number of selections.

12. (canceled)

13. (canceled)

14. A method of navigating through content, the method comprising displaying elements representing navigation history data in a navigation history panel and displaying at least a first menu of a content structure in at least a first panel, the first menu comprising one or more selectable items.

15. A method according to claim 14, wherein the elements representing navigation history data are active elements.

16. A method according to claim 15, wherein the selection of an active element causes the navigation to revert to the selected data in the navigation history data.

17. A computer program product enabling a programmable device when executing said computer program product to function as a method as defined in claim 14.

18. A computer system operable to provide navigation through ordered content, the computer system comprising displaying means for displaying elements representing navigation history data in a navigation history panel and at least a first menu of a structure in at least a first panel, the first menu comprising one or more selectable items.

19. (canceled)
